(19) United States
(12) Patent Application Publication
(10) Pub. No.: US 2006/0230191 A1
(43) Pub. Date: Oct. 12, 2006

(54) METHOD FOR ENABLING OR DISABLING A PERIPHERAL DEVICE THAT IS MAINTAINED ELECTRICALLY CONNECTED TO A COMPUTER SYSTEM

(76) Inventors: Shih-Chi Chang, Taipei Hsien (TW); Chen-Chang Fan, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/908,302

(22) Filed: May 6, 2005

(30) Foreign Application Priority Data
Apr. 11, 2005 (TW) 094111362

(51) Int. Cl. G06F 3/00

(52) U.S. Cl. 710/15

(57) ABSTRACT

A method for enabling or disabling a peripheral device, that uses a basic input output system to control a system chip, modifies the status of a register of a peripheral controller in the south bridge chip of a computer. The method enables or disables the peripheral device through the control of a software application that sends a control command to the basic input output system and therefore can achieve its purpose using only the present configuration of circuits on a motherboard.

### BACKGROUND OF INVENTION

1. Field of the Invention

The present invention relates to a method for enabling or disabling a peripheral device, and more specifically, to a method for enabling or disabling a peripheral device by controlling a system chip with a basic input output system.

2. Description of the Prior Art

As the application of information appliances grows, the likelihood for a personal computer to connect with peripherals also increases, especially to connect via a universal serial bus (USB) interface. Peripheral devices using USB as a computer interface have the main feature of ‘hot plugging,’ which allows a user to remove or exchange a connected peripheral device without shutting down the system. The expandability, flexibility and the problem solving ability of this system are promoted accordingly.

Although hot plugging allows for flexible connection/disconnection of a peripheral device to/from the computer system, it only works for non built-in peripheral devices. For peripheral devices built into the computer system, the prior art control method enables or disables them through another way.

Please refer to FIG. 1, which is an illustration of a prior art method for enabling or disabling a peripheral device 10. The peripheral device 10 is electrically connected to a control chip (a USB control chip 15, for example) through a USB interface, which has four signal lines including +5VDC, Data−, Data+, and GND (Ground). The prior art control method disables the peripheral device 10 by electrically cutting down the 5V power supply to the control chip 15. When it comes to re-enabling the peripheral device 10, one re-supplies the 5V to the control chip 15. The prior art computer system needs to add an additional power control circuit for achieving voltage control of the peripheral device 10.

Please refer to FIG. 2, which is an illustration of another prior art method for enabling or disabling a peripheral device 10. An additional control circuit is deployed on the control chip 15 as a switch. The system chip 20 transmits a general-purpose input output (GPIO) signal as an enabling or disabling signal through the control circuit to realize the enabling or disabling of the peripheral device 10.

However, the prior art introduced in FIG. 2 needs an additional hardware circuit as a control of the peripheral device 10, and the abrasive method of cutting off the power of the peripheral device 10 in FIG. 1 may cause serious damage from sudden electric current change or, more commonly, asynchronous states between the peripheral device 10 and the computer system.

Finally, it is quite common to enable or disable a peripheral device 10 solely by controlling the driver of the peripheral device 10 through the operating system. Such a way of controlling simply stops the operation of the corresponding driver of the peripheral device 10 and in fact does not electrically disconnect the peripheral device 10. Therefore, the peripheral device 10, under such conditions, keeps wasting power of the computer system.

### SUMMARY OF INVENTION

Therefore, the primary objective of the claimed invention is to provide a method for enabling or disabling a peripheral device that is maintained electrically connected to a computer system to solve the above problems.

The claimed invention provides a method for enabling or disabling a peripheral device that is maintained electrically connected to a computer system. The method comprises detecting the peripheral device connected to the computer system, storing a status of the peripheral device on a register, receiving a command for disabling the peripheral device, and after receiving the command for disabling the peripheral device, modifying the status of the register while maintaining the computer system electrically connected to the peripheral device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an illustration of a prior art method for enabling/disabling a peripheral device.

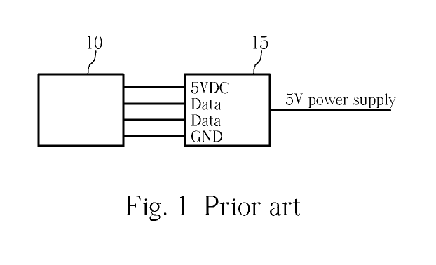

FIG. 2 is an illustration of another prior art method for enabling/disabling a peripheral device.

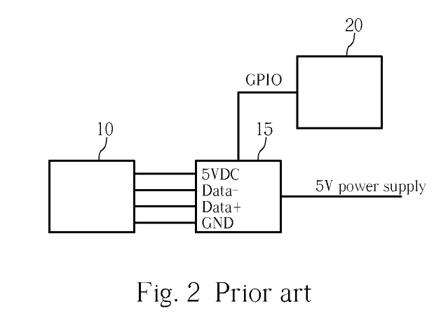

FIG. 3 is a flow chart of the method of enabling/disabling a peripheral device by a basic input output system controlling the system chip.

FIG. 4 is a block diagram of a south bridge chip of a computer system.

### DETAILED DESCRIPTION

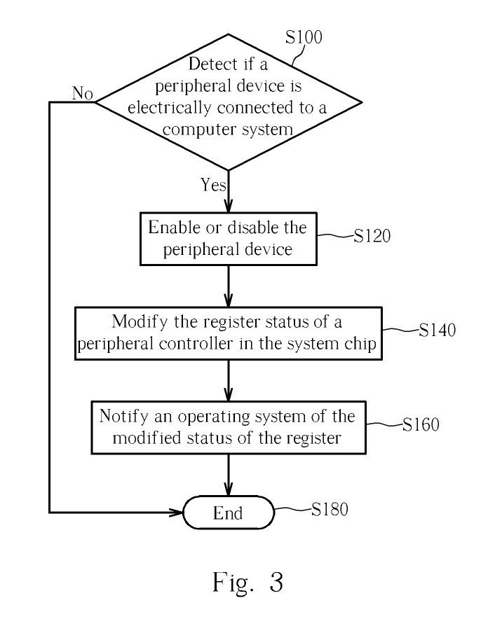

Please refer to FIG. 3. FIG. 3 is a flow chart of the present invention's method of enabling/disabling a peripheral device by a basic input output system (BIOS) controlling a system chip. The operative steps are as follows:

Step S100: Detect if the peripheral device is electrically connected to a computer system; if yes, go to Step S120, if not, go to Step S180;

Step S120: Enable or disable the peripheral device according to a status of the peripheral device stored on a register;

Step S140: Modify the register status of a peripheral controller in the system chip by using BIOS of the computer system, where the modification is enabling or disabling the peripheral device controlled by the peripheral controller;

Step S160: Notify an operating system of the modified status of the register in Step S140; when being notified of the modification, the operating system rescans the status of the peripheral device to make a connection status of the peripheral device in the operating system consistent with the status modified in Step S140;

Step S180: End.

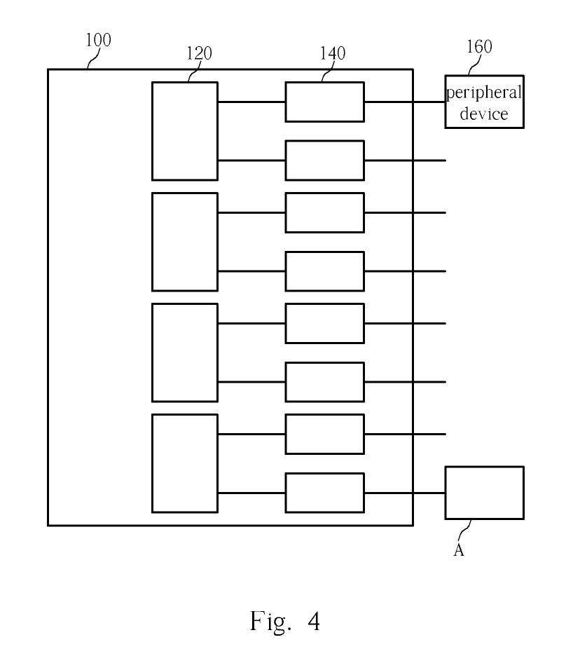

Please refer to FIG. 4, which is a block diagram of a south bridge chip 100 of a computer system. The south bridge chip 100 comprises a plurality of peripheral controllers, including a peripheral controller 120, each comprising a plurality of control ports, including a control port electrically connecting to a peripheral device 160 along with a register 140. The register 140 is for storing a status of the peripheral device 160 controlled by the peripheral controller 120. Therefore, the peripheral device 160 installed in the computer system is controlled by the south bridge chip 100 of the computer system. The status of the peripheral device 160 stored on the register 140 includes the following three flags: ‘exist’, ‘port reset’, and ‘mode’. The ‘exist’ flag records information about whether the control port is connected to a peripheral device 160. The ‘port reset’ flag serves to enable or to disable the peripheral device 160 connected to the control port. The ‘mode’ flag further records the information on different operating modes of the peripheral device 160, i.e. a full speed mode, a silent mode, a sleep mode . . . etc., all of which are useable under enabled status of the peripheral device 160.

When a user starts a command of disabling a peripheral device A through an application program in the operating system, the application program sends the command to the BIOS in INT interrupt. The BIOS directly controls the south bridge chip 100 to modify the ‘exist’ flag of the register 140 as ‘not exist’. Through modifying the status of the register 140, the present invention disables the peripheral device A. While the peripheral device A is maintained electrically connected to the computer system, the south bridge chip 100 notifies the operating system of the disablement of the peripheral device A. Next, as Step S160 states, after the operating system receives the notification from the south bridge chip 100, it executes a scan of the status of the peripheral device 160. While scanning the control port connected to the peripheral device A, the status of the peripheral device A, as stored in the register 140, will cause the result of the scan to be ‘not exist’ for the control port connected to the peripheral device A, which means the peripheral device A has been removed from the computer system, from the operating system's point of view. The operating system will then adjust the status of the peripheral device A to ‘not exist.’ Thus, the present invention's method effectively disables the connection of the peripheral device.

Since the peripheral device A isn't electrically disconnected from the computer system, the user can use a similar method for enabling the peripheral device A. The application program sends a command for enabling the peripheral device A to the BIOS, then the BIOS modifies the status of the register 140. Notification of the operating system takes place afterwards, causing the operating system to rescan the status of the peripheral devices and restore the connection to the peripheral device A.

Additionally, as Step S100 describes, the present invention's method works while the peripheral device 160 is maintained electrically connected to the computer system. That allows an application program to directly control the enabling or disabling of the peripheral device 160. In Step S120, the initial status of a peripheral device 160 is decided by the status recorded on the register 140. To take a bluetooth wireless network chip of a notebook computer as an example, the network chip is disabled by the present invention's method through an application program, before the notebook computer shuts down. If the network chip isn't re-enabled through the application program restarting, the network chip will remain disabled to the operating system, that is, it will ‘not exist’ to the operating system. Therefore, a user doesn't have to set the peripheral device 160 to the previous status every time the computer system restarts.

The present invention's method of controlling a peripheral device controls not only the peripheral devices with a USB interface but also any peripheral devices with an interface that can be handled by the BIOS, such as a peripheral device with peripheral component interconnect (PCI), integrated drive electronics (IDE), enhanced integrated drive electronics (EIDE) interface, a sound chip, a network chip . . . etc.

Common USB peripheral devices use the system power as their power source, which leads to the result that a prior art computer system will not enter C2 or C3 power saving states with a USB peripheral device connected. But the present invention's method of enabling or disabling a peripheral device controls the connection of the peripheral device such that the computer system will not actively provide any power to the peripheral device when the peripheral device is disabled, though maintained electrically connected to the computer system. In such a way, the goal of further saving power can be realized and the operating system will enter a higher level of power saving modes without any problem.

The present invention uses the existing hardware circuitry of a computer system, without adding any additional control circuitry, to achieve the goal of enabling or disabling of a peripheral device. The method directs the BIOS, through an application program, to modify the register status of each peripheral controller of a south bridge chip. This raises the power saving performance of a peripheral device, helps troubleshooting of the device, and even achieves the enabling or disabling of a peripheral device that can't be directly accessed by hand.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enabling or disabling a peripheral device that is maintained electrically connected to a computer system, the method comprising:
(a) detecting the peripheral device connected to the computer system;
(b) storing a status of the peripheral device on a register;
(c) receiving a command for disabling the peripheral device; and
(d) when receiving the command for disabling the peripheral device, modifying the status of the register while maintaining the computer system and the peripheral device electrically connected.

2. The method of claim 1 further comprising notifying an operating system of the modification of the register in step (d).

3. The method of claim 1 further comprising step (e) setting the status of the peripheral by a system chip.

4. The method of claim 3 wherein in step (e) a basic input output system (BIOS) controls the system chip to set up the status of the peripheral.

5. The method of claim 1 further comprising enabling the peripheral after the execution of step (d) when receiving a command for enabling the peripheral.
